(19) United States
(12) Patent Application Publication
(10) Pub. No.: US 2014/0321529 A1
(43) Pub. Date: Oct. 30, 2014

(54) VIDEO ENCODING AND/OR DECODING METHOD AND VIDEO ENCODING AND/OR DECODING APPARATUS

(71) Applicant: Intellectual Discovery Co., Ltd., Seoul (KR)

(72) Inventors: Tae Young JUNG, Seoul (KR); Dong Jin PARK, Namyangju-si (KR); Dae Yeon KIM, Seoul (KR)

(73) Assignee: Intellectual Discovery Co., Ltd., Seoul (KR)

(21) Appl. No.: 14/265,490

(22) Filed: Apr. 30, 2014

(30) Foreign Application Priority Data
Apr. 30, 2013 (KR) 10-2013-0048111

(51) Int. Cl. H04N 19/436; H04N 19/13; H04N 19/105; H04N 19/146; H04N 19/182; H04N 19/196

(52) U.S. Cl. CPC H04N 19/00521; H04N 19/00303; H04N 19/00369; H04N 19/00024; H04N 19/00169; H04N 19/00121
USPC 375/240.02

(57) ABSTRACT

Disclosed is a video processing apparatus. The video processing apparatus includes a video central processing unit to communicate with a host and to parse parameter information or slice header information from video data input from the host, and a plurality of video processing units to process a video based on the parsed information according to control by the central video processing unit, wherein the video central processing unit determines an entry point of a video bitstream to be allocated to each of the video processing units in view of a number of pixels to be processed by each video processing unit.

### CROSS-REFERENCE TO RELATED APPLICATION

This application claims the benefit of priority of Korean Patent Application No. 10-2013-0048111 filed on Apr. 30, 2013, which is incorporated by reference in its entirety herein.

### TECHNICAL FIELD

The present invention relates to a video encoding and/or decoding method and a video encoding and/or decoding apparatus, and more particularly to a method and an apparatus for scalably processing a video using a plurality of processing units.

### BACKGROUND ART

With need for ultrahigh definition (UHD), existing video compression techniques have difficulty in accommodating sizes of storage media and bandwidths of transfer media. Accordingly a novel standard for compression of UHD videos is needed.

High Efficiency Video Coding (HEVC) is available for a video stream serviced through the Internet, 3G and LTE networks, in which not only UHD but also full high definition (FHD) or high definition (HD) videos can be compressed in accordance with HEVC.

A UHD TV is considered to mainly provide 4K UHD at 30 frames per second (fps) in the short term, while the number of pixels to be processed per second is expected to increase to 4K 60 fps/120 fps, 8K 30 fps/60 fps, etc.

To cost-effectively deal with different resolutions and frame rates in such applications, a video encoding apparatus which is easily extensible based on performance and functions required for applications is needed.

### DISCLOSURE

### Technical Problem

The present invention is conceived to solve the aforementioned issues, and an aspect of the present invention is to provide a video processing method and a video processing apparatus which include a V-CPU for allocating entry points so that a number of pixels to be allocated to each of multi V-Cores is as equal as possible.

### Technical Solution

An embodiment of the present invention provides a video encoding and/or decoding apparatus including a video central processing unit to communicate with a host and to parse parameter information or slice header information from video data input from the host, and a plurality of video processing units to process a video based on the parsed information according to control by the central video processing unit, wherein the video central processing unit determines an entry point of a video bitstream to be allocated to each of the video processing units in view of a number of pixels to be processed by each video processing unit.

Another embodiment of the present invention provides a video encoding and/or decoding method of a video encoding and/or decoding apparatus including a video central processing unit and a plurality of video processing units, the video decoding method including parsing, by the video central processing unit, parameter information or slice header information from video data input from a host while communicating with the host, determining, by the video central processing unit, an entry point of a video bitstream to be allocated to each of the video processing units in view of a number of pixels to be processed by each video processing units, and processing, by the video processing units, a video based on the parsed information according to control by the video central processing unit.

Meanwhile, the video processing method may be implemented by a computer-readable recording medium recoding a program to be executed in a computer.

### Advantageous Effects

According to exemplary embodiments of the present invention, there is provided a video processing apparatus and method capable of effectively processing pixels when a large number of pixels, for example, 4K 60 fps/120 fps, 8K 30 fps/60 fps, etc. as in UHD, are processed per second.

### DESCRIPTION OF DRAWINGS

FIG. 1 is a block diagram illustrating a configuration of a video encoding apparatus according to an exemplary embodiment of the present invention.

FIG. 2 illustrates a method of processing a video based on partitioned blocks.

FIG. 3 is a block diagram illustrating a configuration for performing inter prediction in the encoding apparatus according to an exemplary embodiment.

FIG. 4 is a block diagram illustrating a configuration of a video decoding apparatus according to an exemplary embodiment of the present invention.

FIG. 5 is a block diagram illustrating a configuration for performing inter prediction in the decoding apparatus according to an exemplary embodiment.

FIG. 6 illustrates a layer structure of a video decoding apparatus according to an exemplary embodiment of the present invention.

FIG. 7 is a timing view illustrating a video decoding operation of a VPU according to an exemplary embodiment of the present invention.

FIG. 8 illustrates operations of a V-CPU in detail according to an exemplary embodiment of the present invention.

FIG. 9 illustrates a method of controlling synchronization of multi V-Cores for parallel data processing of the multi V-Cores performed by the V-CPU according to an exemplary embodiment of the present invention.

FIG. 10 illustrates a method of determining a number of V-Cores to be used for parallel data processing performed by the V-CPU according to an exemplary embodiment of the present invention.

FIGS. 11 and 12 illustrate a method of retrieving entry points performed by the V-CPU according to an exemplary embodiment of the present invention.

### MODE FOR INVENTION

Hereinafter, exemplary embodiments of the present invention will be described in detail with reference to the accompanying drawings so that this disclosure will fully convey the scope of the invention to those having ordinary knowledge in the art to which the present invention pertains. This invention may, however, be embodied in many different forms and should not be construed as limited to the exemplary embodiments set forth herein. Configurations or elements unrelated to the description are omitted in the drawings as to clarify the present invention, and like reference numerals refer to like elements throughout.

It will be understood that when an element is referred to as being “connected to” another element, the element can be not only directly connected to another element but also electrically connected to another element via an intervening element.

It will be further understood that when a member is referred to as being “on” another member, the member can be directly on another member or an intervening member.

Unless specified otherwise, the terms “comprise,” “include,” “comprising,” and/or “including” specify the presence of elements and/or components, but do not preclude the presence or addition of one or more other elements and/or components. The terms “about” and “substantially” used in this specification to indicate degree are used to express a numerical value or an approximate numerical value when a mentioned meaning has a manufacturing or material tolerance and are used to prevent those who are dishonest and immoral from wrongfully using the disclosure of an accurate or absolute numerical value made to help understanding of the present invention. The term “stage (of doing)” of “stage of” used in this specification to indicate degree does not mean “stage for.”

It will be noted that the expression “combination thereof” in a Markush statement means a mixture or combination of one or more selected from the group consisting of elements mentioned in the Markush statement, being construed as including one or more selected from the group consisting of the elements.

To encode a picture and a depth map thereof, High Efficiency Video Coding (HEVC) providing optimal coding efficiency among existing video coding standards, which is under joint standardization by the Moving Picture Experts Group (MPEG) and the Video Coding Experts Group (VCEG), may be used as an example, without being limited thereto.

Generally, an encoding apparatus includes an encoding process and a decoding process, while a decoding apparatus includes a decoding process. The decoding process of the decoding apparatus may be the same as the decoding process of the encoding apparatus. Thus, the following description will be made on the encoding apparatus.

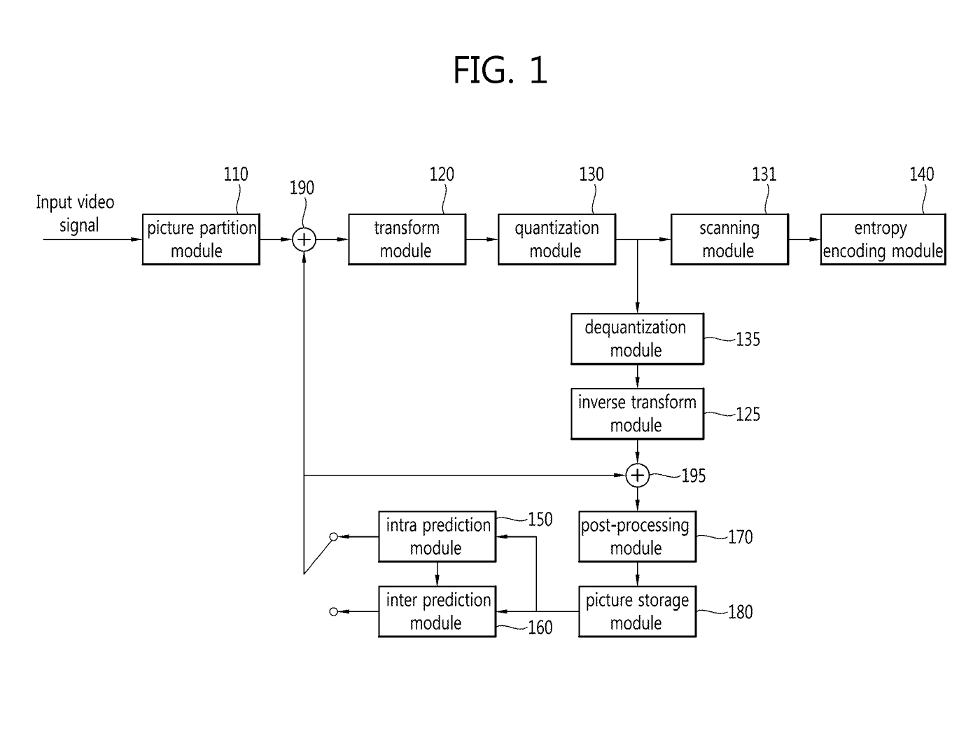

FIG. 1 is a block diagram illustrating a configuration of a video encoding apparatus according to an exemplary embodiment of the present invention.

Referring to FIG. 1, the video encoding apparatus 100 includes a picture partition module 110, a transform module 120, a quantization module 130, a scanning module 131, an entropy encoding module 140, an intra prediction module 150, an inter prediction module 160, a dequantization module 135, an inverse transform module 125, a post-processing module 170, a picture storage module 180, a subtractor 190 and an adder 195.

The picture partition module 110 parses an input video signal, partitions a picture into coding units (CUs) of a predetermined size in each largest coding unit (LCU) to determine a prediction mode, and determines a size of prediction unit (PU) by each CU.

The picture partition module 110 transmits a PU to be encoded to the intra prediction module 150 or the inter prediction module 160 based on a prediction mode or prediction method. Further, the picture partition module 110 transmits the PU to be encoded to the subtractor 190.

A picture may include a plurality of slices, and a slice may include a plurality of LCUs.

Each LCU may be partitioned into a plurality of CUs, and an encoding apparatus may add information (flag) about partition to a bitstream. A decoding apparatus may recognize an LCU position using an address (LcuAddr).

A CU, which is not allowed to be partitioned, is considered as a PU, and the decoding apparatus may recognize a PU position using a PU index.

A PU may be divided into a plurality of partitions. Further, a PU may include a plurality of transform units (TUs).

In this case, the picture partition module 110 may transmit video data to the subtractor 190 according to a block unit with a predetermined size, for example, a PU or TU, based on a determined encoding mode.

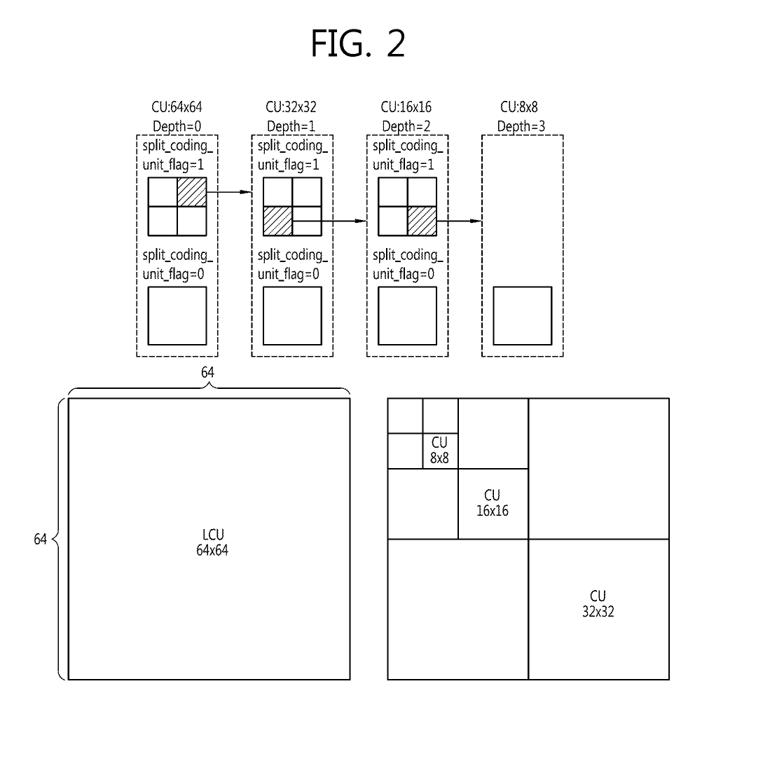

Referring to FIG. 2, a coding tree unit (CTU) is used as a unit for video encoding and defined as various square shapes. A CTU includes a CU.

A CU has shape of a quadtree, and a 64×64 LCU with a depth of 0 is recursively partitioned to a depth of 3, that is, 8×8 CUs, thereby carrying out encoding based on an optimal PU.

A unit for performing prediction is defined as a PU, and each CU is partitioned into a plurality of blocks for prediction, in which prediction is performed separately for square blocks and rectangular blocks.

The transform module 120 transforms a residual block as a residual signal between an original block of the input PU and a prediction block generated by the intra prediction module 150 or the inter prediction module 160. The residual block includes a CU or PU. The residual block formed of a CU or PU is partitioned into optimal TUs to be transformed. Different transform matrices may be determined based on an intra prediction mode or inter prediction mode. A residual signal of intra prediction has directivity based on an intra prediction mode, and accordingly a transform matrix may be adaptively determined based on an intra prediction mode.

The TUs may be transformed using two (horizontal and vertical) one-dimensional (1D) transform matrices. For example, in inter prediction, a predetermined single transform matrix is used.

In intra prediction, however, when an intra prediction mode is a horizontal mode, the residual block is more likely to have vertical directivity, and thus a discrete cosine transform (DCT)-based integer matrix is applied in a vertical direction and a discrete sine transform (DST)- or Karhunen-Loeve transform (KLT)-based integer matrix is applied in a horizontal direction. When an intra prediction mode is a vertical mode, a DST- or KLT-based integer matrix is applied in the vertical direction and a DCT-based integer matrix is applied in the horizontal direction.

In a DC mode, a DCT-based integer matrix is applied in both directions. In intra prediction, a transform matrix may be adaptively determined based on a TU size.

The quantization module 130 determines a quantization step size for quantizing coefficients of the residual block transformed by the transform matrices. The quantization step size is determined by a CU of a predetermined size or larger (hereinafter, “quantization unit”).

The predetermined size may be 8×8 or 16×16. Coefficients of the transform block are quantized using a quantization matrix determined on the determined quantization step size and prediction mode.

The quantization module 130 uses a quantization step size of a neighboring quantization unit to a current quantization unit as a quantization step size predictor of the current quantization unit.

The quantization module 130 may generate the quantization step size predictor of the current quantization unit using one or two effective quantization step sizes by retrieving a left quantization unit, an upper quantization unit and a top left quantization unit of the current quantization unit in order.

For example, an effective quantization step size retrieved first in the foregoing order may be determined as the quantization step size predictor. Alternatively, an average value of two effective quantization step sizes retrieved in the foregoing order may be determined as the quantization step size predictor, or one effective quantization step size, if retrieved only, may be determined as the quantization step size predictor.

When the quantization step size predictor is determined, the quantization module 130 transmits a differential value between the quantization step size of the current CU and the quantization step size predictor to the entropy encoding module 140.

Meanwhile, the left CU, the upper CU and the top left CU of the current CU may be absent. Instead, a preceding CU in encoding order may be present in the LCU.

Thus, quantization step sizes of the neighboring quantization units to the current CU and a quantization unit right before the current CU in encoding order in the LCU may be candidates.

In this case, 1) the left quantization unit of the current CU, 2) the upper quantization unit of the current CU, 3) the top left quantization unit of the current CU and 4) the quantization unit right before the current CU in encoding order may have higher priorities in order. The priority order may change, and the top left quantization unit may be omitted.

The quantized transform block is provided to the dequantization module 135 and the scanning module 131.

The scanning module 131 scans and transforms the coefficients of the quantized transform block into 1D quantization coefficients. Distribution of the coefficients of the transform block after quantization may be dependent on the intra prediction mode, and thus a scanning method is determined based on the intra prediction mode.

Further, a coefficient scanning method may change based on a TU size. The scanning pattern may change depending on a directional intra prediction mode. The quantization coefficients are scanned in reverse order.

When the quantized coefficients are divided into a plurality of subsets, the same scanning pattern is applied to quantization coefficients in each subset. Zigzag scanning or diagonal scanning is applied as a scanning pattern to each subset. Although a scanning pattern is preferably applied in a forward direction from a main subset including DC to other subsets, scanning may be also performed in a reverse direction.

The same scanning pattern as for quantized coefficients in the subsets may be set for the subsets. In this case, the scanning pattern for the subsets is determined on an intra prediction mode. Meanwhile, the encoding apparatus transmits information indicating a position of a last quantization coefficient which is not 0 in the TU to the decoding apparatus.

Information indicating a position of a last quantization coefficient which is not 0 in each subset may be also transmitted to the decoding apparatus.

The dequantization module 135 dequantizes the quantized quantization coefficients. The inverse transform module 125 reconstructs the dequantized transform coefficients into the residual block in a spatial domain. The adder adds the residual block reconstructed by the inverse transform module and the prediction block received from the intra prediction module 150 or the inter prediction module 160, thereby generating a reconstructed block.

The post-processing module 170 performs a deblocking filtering process for removing a blocking effect occurring in the reconstructed picture, an adaptive offset application process for compensating for a difference value from the original picture by a pixel, and an adaptive loop filtering process for compensating for a difference value from the original picture by a CU.

The deblocking filtering process is preferably applied to a boundary between PUs and TUs having a predetermined size or larger. The size may be 8×8. The deblocking filtering process includes determining a boundary to be filtered, determining a boundary filtering strength to be applied to the boundary, determining whether to apply a deblocking filter, and selecting a filter to be used for the boundary if the deblocking filter is determined to be applied.

Application of the deblocking filter is determined based on whether i) the boundary filtering strength is greater than 0 and ii) whether a value representing a variation of pixel values on a boundary between two adjacent blocks (P and Q blocks) to the boundary to be filtered is lower than a first reference value determined by a quantization parameter.

At least two filters may be used. When an absolute value of a difference between two pixels disposed on the boundary between the blocks is greater than or the same as a second reference value, a relatively weak filter is selected.

The second reference value is determined on the quantization parameter and the boundary filtering strength.

The adaptive offset application process is to decrease a distortion between a pixel in a picture having been subjected to the deblocking filter and an original pixel. Performing the adaptive offset application process may be determined by a picture or slice.

A picture or slice may be partitioned into a plurality of offset regions, and an offset type may be determined for each offset region. The offset type may include a predetermined number (for example, 4) of edge offset types and two band offset types.

When the offset type is an edge offset type, an edge type to which each pixel belongs is determined and a corresponding offset is applied. The edge type is determined based on distribution of values of two neighboring pixels to a current pixel.

The adaptive loop filtering process may be performed based on a value resulting from comparison of the reconstructed picture having been subjected to the deblocking filtering process or the adaptive offset application process and the original picture. In the adaptive loop filtering process, a determined adaptive loop filter (ALF) may be applied to all pixels included in a 4×4 or 8×8 block.

Application of the adaptive loop filter may be determined by a CU. A size and coefficient of the loop filter to be used may change for each CU. Information indicating whether the ALF is applied to each CU may be included in each slice header.

In a chroma signal, application of the ALF may be determined by a picture. The loop filter may have a rectangular shape, unlike in a luma signal.

Application of adaptive loop filtering may be determined by a slice. Thus, information indicating whether adaptive loop filtering is applied to a current slice is included in a slice header or picture header.

When the information indicates that adaptive loop filtering is applied to the current slice, the slice header or picture header further includes information indicating a horizontal and/or vertical length of a filter for a luma component used for adaptive loop filtering.

The slice header or picture header may include information indicating a number of filter sets. Here, when the number of filter sets is 2 or greater, filter coefficients may be encoded using a prediction method. Thus, the slice header or picture header may include information indicating whether the filter coefficients are encoded by the prediction method, and includes a predicted filter coefficient if the prediction method is used.

Meanwhile, in addition to luma components, chroma components may be also adaptively filtered. Thus, the slice header or picture header may include information indicating whether each chroma component is filtered. In this case, information on whether filtering is performed on Cr and Cb may be subjected to joint coding, that is, multi-coding, so as to reduce a bit number.

Here, in chroma components, since both Cr and Cb are more likely not to be filtered so as to reduce complexity, a smallest index is allocated to a case where both Cr and Cb are not filtered to conduct entropy encoding.

A largest index is allocated to a case where both Cr and Cb are filtered to conduct entropy encoding.

The picture storage module 180 receives post-processed video data from the post-processing module 170 to reconstruct and store a video by a picture. A picture may be a video of a frame unit or a video of a field unit. The picture storage module 180 may include a buffer (not shown) to store a plurality of pictures.

The inter prediction module 160 performs motion estimation using at least one reference picture stored in the picture storage module 180 and determines a reference picture index representing the reference picture and a motion vector.

The inter prediction module 160 extracts and outputs a prediction block corresponding to the PU to be encoded from the reference picture used for motion estimation among the plurality of pictures stored in the picture storage module 180 according to the determined reference picture index and motion vector.

The intra prediction module 150 performs intra predictive encoding using a value of a reconstructed pixel included in the picture including the current PU.

The intra prediction module 150 receives the current PU to be subjected to predictive encoding and selects one of a preset number of intra prediction modes according to a size of the current block to perform intra prediction.

The intra prediction module 150 adaptively filters a reference pixel to generate an intra prediction block. When the reference pixel is unavailable, reference pixels may be generated using available reference pixels.

The entropy encoding module 140 entropy-encodes the quantization coefficients quantized by the quantization module 130, intra prediction information received from the intra prediction module 150 and motion information received from the inter prediction module 160.

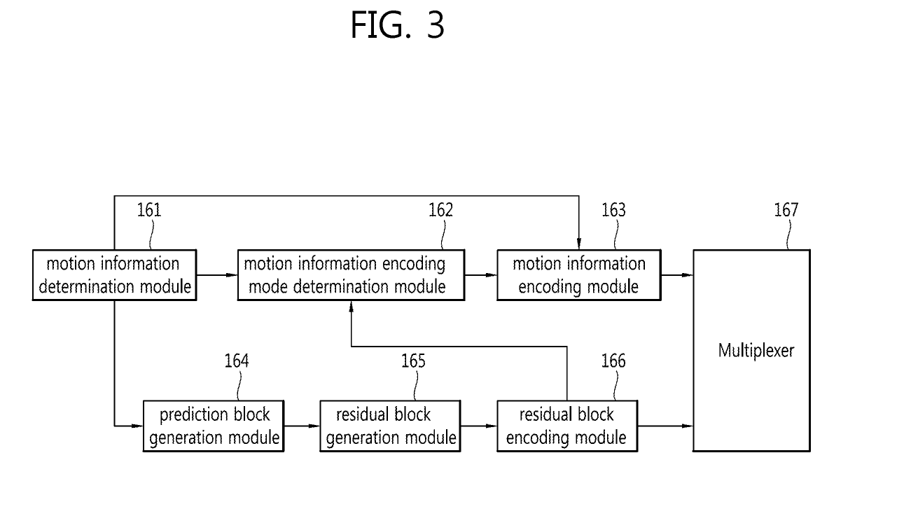

FIG. 3 is a block diagram illustrating a configuration for performing inter prediction in the encoding apparatus according to an exemplary embodiment. An inter predictive encoding apparatus may include a motion information determination module 161, a motion information encoding mode determination module 162, a motion information encoding module 163, a prediction block generation module 164, a residual block generation module 165, a residual block encoding module 166 and a multiplexer 167.

Referring to FIG. 3, the motion information determination module 161 determines motion information on a current block. The motion information includes a reference picture index and a motion vector. The reference picture index indicates any one picture previously encoded and reconstructed.

When the current block is subjected to unidirectional inter predictive encoding, the reference picture index indicates any one of reference pictures included in list 0 (L0). When the current block is subjected to bidirectional inter predictive encoding, the reference picture index may include a reference picture index indicating one of reference pictures of list 0 (L0) and a reference picture index indicating one of reference pictures of list 1 (L1).

Further, when the current block is subjected to bidirectional inter predictive encoding, the reference picture index may include an index indicating one or two pictures among reference pictures of a combined list (LC) of list 0 and list 1.

The motion vector indicates a position of a prediction block in a picture indicated by each reference picture index. The motion vector may be a picture unit (integer unit) or a sub-pixel unit.

For example, the motion vector may have a resolution of ½, ¼, ⅛ or 1/16 pixel. When the motion vector is not an integer unit, the prediction block is generated from integer pixels.

The motion information encoding mode determination module 162 determines whether to use a skip mode, a merge mode or an AMVP mode for encoding the motion information on the current block.

The skip mode is used when a skip candidate having the same motion information as the motion information on the current block is present and a residual signal is 0. Also, the skip mode is used when the current block has the same size as a CU. The current block may be regarded as a PU.

The merge mode is used when a merge candidate having the same motion information as the motion information on the current block is present. The merge mode is used when the current block has a different size from a CU, or a residual signal is present if the current block has the same size as the CU. The merge candidate may be the same as the skip candidate.

The AMVP mode is used when the skip mode and the merge mode are not adopted. An AMVP candidate having a most similar motion vector to the motion vector of the current block is selected as an AMVP predictor.

The motion information encoding module 163 encodes the motion information according to a mode determined by the motion information encoding mode determination module 162. When a motion information encoding mode is the skip mode or merge mode, a merge motion vector encoding process is performed. When the motion information encoding mode is the AMVP mode, an AMVP encoding process is performed.

The prediction block generation module 164 generates a prediction block using the motion information on the current block. When the motion vector is an integer unit, the prediction block generation module 164 generates a prediction block of the current block by copying a block corresponding to the position represented by the motion vector in the picture indicated by the reference picture index.

When the motion vector is not an integer unit, however, pixels of the prediction block are generated from integer pixels in the picture indicated by the reference picture index.

In this case, in a luma pixel, a predictive pixel may be generated using an 8-tap interpolation filter. In a chroma pixel, a predictive pixel may be generated using a 4-tap interpolation filter.

The residual block generation module 165 generates a residual block using the current block and the prediction block of the current block. When the current block has a size of 2N×2N, the residual block is generated using the current block and a 2N×2N prediction block corresponding to the current block.

However, when the current block used for prediction has a size of 2N×N or N×2N, prediction blocks for two 2N×N blocks forming a 2N×2N block are generated and then a final prediction block of 2N×2N is generated using the two 2N×N prediction blocks.

Subsequently, the 2N×2N residual block is generated using the 2N×2N prediction block. Overlap smoothing may be applied to pixels on a boundary between the two 2N×N prediction blocks so as to resolve discontinuities on the boundary.

The residual block encoding module 166 divides the generated residual block into one or more TUs. Each TU is transcoded, quantized and entropy-encoded. Here, a size of the TUs may be determined on a quadtree depending on a size of the residual block.

The residual block encoding module 166 transforms the residual block generated by the inter prediction method using an integer transform matrix. The transform matrix is an integer DTC matrix.

The residual block encoding module 166 uses a quantization matrix to quantize coefficients of the residual block transformed by the transform matrix. The quantization matrix is determined on a quantization parameter.

The quantization parameter is determined by a CU of a predetermined size or larger. The predetermined size may be 8×8 or 16×16. Thus, when a current CU has a smaller size than the predetermined size, only a quantization parameter of a first CU in encoding order among a plurality of CUs smaller than the predetermined size is encoded, without necessarily encoding quantization parameters of remaining CUs since the quantization parameters of the remaining CUs are the same as the parameter.

The coefficients of the transform block are quantized using the quantization matrix determined based on the determined quantization parameter and a prediction mode.

The quantization parameter determined by the CU of the predetermined size or larger is subjected to predictive coding using a quantization parameter of a neighboring CU to the current CU. A quantization parameter predictor of the current CU may be generated using one or two effective quantization parameters by retrieving a left CU and an upper CU of the current CU in order.

For example, an effective quantization parameter retrieved first in the foregoing order may be determined as the quantization parameter predictor. Alternatively, a first effective quantization parameter may be determined as the quantization parameter predictor by retrieving the left CU and a CU right before the current CU in encoding order.

The quantized coefficients of the transform block are transformed via scanning into 1D quantization coefficients. Different types of scanning may be set depending on an entropy encoding mode. For example, when context-based adaptive binary arithmetic coding (CABAC) is used for encoding, the inter predictive coded quantized coefficients may be scanned by one predetermined method, for example, zigzag or diagonal raster scanning. When context-adaptive variable-length coding is used for encoding, a different method from the above may be used for scanning.

For example, zigzag scanning may be used for inter prediction, while a scanning method may be determined based on an intra prediction mode in intra prediction. Further, different coefficient scanning methods may be used based on a TU size.

The scanning pattern may change based on a directional intra prediction mode. The quantization coefficients are scanned in reverse order.

The multiplexer 167 multiplexes the motion information encoded by the motion information encoding module 163 and residual signals encoded by the residual block encoding module. The motion information may vary depending on an encoding mode.

That is, in the skip or merge mode, the motion information includes an index indicating a predictor only. In the AMVP mode, however, the motion information includes a reference picture index of the current block, a differential motion vector, and an AMVP index.

Hereinafter, operations of the intra prediction module 150 will be described in detail according to an exemplary embodiment.

First, the intra prediction module 150 receives prediction mode information and a size of a prediction block from the picture partition module 110, wherein the prediction mode information indicates an intra mode. The prediction block may have a square shape with a size of 64×64, 32×32, 16×16, 8×8 or 4×4, without being limited thereto. That is, the size of the prediction block may be non-square, instead of square.

Next, the intra prediction module 150 reads a reference pixel from the picture storage module 180 to determine an intra prediction mode of the prediction block.

The intra prediction module 150 investigates whether the reference pixel is unavailable and determines whether to generate a reference pixel. Reference pixels are used to determine an intra prediction mode of the current block.

When the current block is disposed on an upper boundary of a current picture, upper neighboring pixels to the current block are not defined. Further, when the current block is disposed on a left boundary of the current picture, left neighboring pixels to the current block are not defined.

These pixels are determined to be unavailable. Further, when the current block is disposed on a boundary of a slice, upper or left neighboring pixels to the slice, which are not encoded and reconstructed first, are determined to be unavailable.

As described above, when the left or upper neighboring pixels to the current block are absent or there are no pixels encoded and reconstructed in advance, only available pixels may be used to determine the intra prediction mode of the current block.

However, reference pixels in unavailable positions may be generated using available reference pixels for the current block. For example, when pixels of an upper block are unavailable, part or whole of left pixels may be used to generate upper pixels, and vice versa.

That is, a reference pixel may be generated by copying an available reference pixel in a closest position to a position of an unavailable reference pixel in a predetermined direction. When an available reference pixel is absent in the predetermined direction, a reference pixel may be generated by copying an available reference pixel in a closest position in an opposite direction.

Meanwhile, upper and left pixels of the current block, even though present, may be determined as unavailable reference pixels depending on an encoding mode of a block including these pixels.

For example, when a block including upper neighboring reference pixels to the current block is reconstructed via inter encoding, these reference pixels may be determined as unavailable pixels.

In this case, available reference pixels may be generated using pixels included in a neighboring block to the current block which is reconstructed via intra encoding. Here, the encoding apparatus transmits information indicating that an available reference pixel is determined based on an encoding mode to the decoding apparatus.

Next, the intra prediction module 150 determines an intra prediction mode of the current block using the reference pixels. A number of intra prediction modes allowable for the current block may change depending on a size of the block. For example, when the current block has a size of 8×8, 16×16 or 32×32, 34 intra prediction modes may be used. When the current block has a size of 4×4, 17 intra prediction modes may be used.

The 34 or 17 intra prediction modes may include at least one non-directional mode and a plurality of directional modes.

The at least one non-directional mode may be a DC mode and/or a planar mode. When the DC mode and the planar mode are included in the non-directional mode, 35 intra prediction modes may be available regardless of the size of the current block.

Here, the intra prediction mode of the current block may include the two non-directional modes, the DC mode and the planar mode, and 33 directional modes.

The planar mode generates the prediction block of the current block using a value of at least one bottom right pixel of the current block (or a predictive value of the pixel, hereinafter “first reference value”) and reference pixels.

A configuration of a video decoding apparatus according to an exemplary embodiment of the present invention may be derived from the configuration of the video encoding apparatus described above with reference to FIGS. 1 to 3, in which a video may be decoded, for example, by performing the encoding process illustrated in FIG. 1 in reverse order.

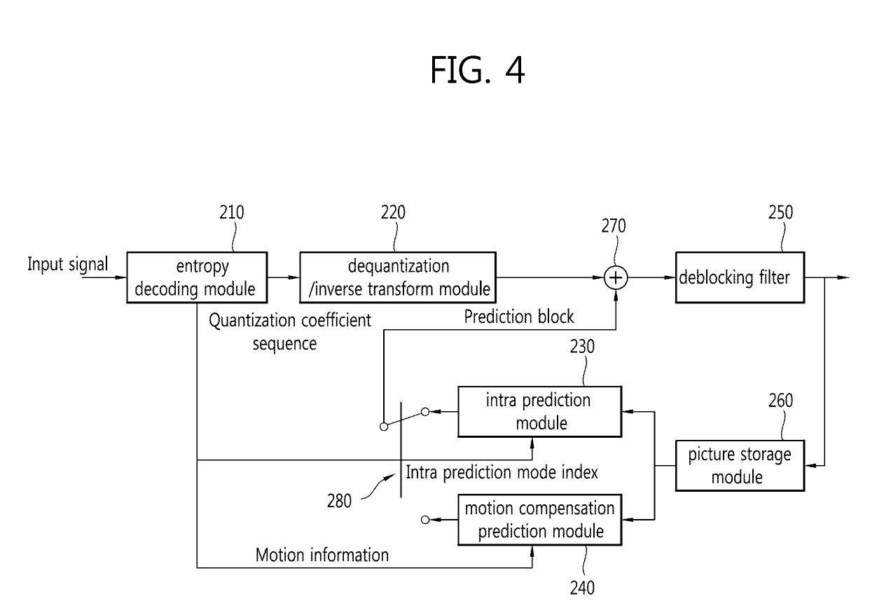

FIG. 4 is a block diagram illustrating a configuration of a video decoding apparatus according to an exemplary embodiment of the present invention.

Referring to FIG. 4, the video decoding apparatus according to the present embodiment includes an entropy decoding module 210, a dequantization/inverse transform module 220, an adder 270, a deblocking filter 250, a picture storage module 260, an intra prediction module 230, a motion compensation prediction module 240 and an intra/inter changeover switch 280.

The entropy decoding module 210 decode an encoded bitstream transmitted from the video encoding apparatus to separate into an intra prediction mode index, motion information, a quantization coefficient sequence, or the like. The entropy decoding module 210 provides the decoded motion information to the motion compensation prediction module 240.

The entropy decoding module 210 provides the intra prediction mode index to the intra prediction module 230 and the dequantization/inverse transform module 220. Also, the entropy decoding module 210 provides the quantization coefficient sequence to the intra prediction module 230 and the dequantization/inverse transform module 220.

The dequantization/inverse transform module 220 transforms the quantization coefficient sequence into a two-dimensional (2D) array of dequantization coefficients. One of a plurality of scanning patterns is selected for transformation. One of the scanning patterns is selected based on at least one of a prediction mode of a current block, that is, either of intra prediction and inter prediction, and an intra prediction mode.

The intra prediction mode is received from the intra prediction module or the entropy decoding module.

The dequantization/inverse transform module 220 reconstructs quantization coefficients using a quantization matrix selected among a plurality of quantization matrices to the 2D array of dequantization coefficients. Different quantization matrices are used depending on a size of the current block to be reconstructed, and a quantization matrix is selected for blocks of the same size based on the prediction mode of the current block and the intra prediction mode.

Then, the reconstructed quantization coefficients are inverse-transformed to reconstruct a residual block.

The adder 270 adds the residual block reconstructed by the dequantization/inverse transform module 220 and a prediction block generated by the intra prediction module 230 or the motion compensation prediction module 240, thereby reconstructing a picture block.

The deblocking filter 250 performs deblocking filtering on the picture reconstructed by the adder 270. Accordingly, deblocking artifacts due to picture loss in the quantization process may be reduced.

The picture storage module 260 is a frame memory to store a local decoding picture having been subjected to deblocking filtering by the deblocking filter 250.

The intra prediction module 230 reconstructs the intra prediction mode of the current block based on the intra prediction mode index received from the entropy decoding module 210. The intra prediction module 230 generates a prediction block based on the reconstructed intra prediction mode.

The motion compensation prediction module 240 generates a prediction block of the current block from a picture stored in the picture storage module 260 based on motion vector information. When point-precision motion compensation is applied, a selected interpolation filter is used to generate the prediction block.

The intra/inter changeover switch 280 provides the prediction block generated by either of the intra prediction module 230 and the motion compensation prediction module 240 to the adder 270 based on the encoding mode.

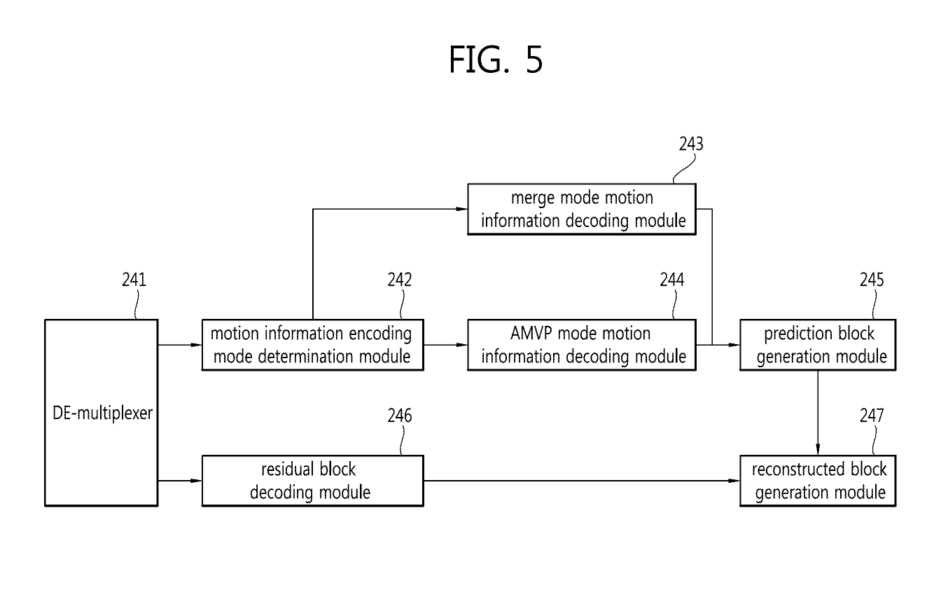

FIG. 5 is a block diagram illustrating a configuration for performing inter prediction in the decoding apparatus according to an exemplary embodiment. An inter predictive decoding apparatus includes a de-multiplexer 241, a motion information encoding mode determination module 242, a merge mode motion information decoding module 243, an AMVP mode motion information decoding module 244, a prediction block generation module 245, a residual block decoding module 246 and a reconstructed block generation module 247.

Referring to FIG. 5, the de-multiplexer 245 demultiplexes encoded motion information and encoded residual signals from a received bitstream. The de-multiplexer 241 transmits the demultiplexed motion information to the motion information encoding mode determination module 242 and transmits the demultiplexed residual signals to the residual block decoding module 246.

The motion information encoding mode determination module 242 determines a motion information encoding mode of a current block. The motion information encoding mode determination module 242 determines that the motion information encoding mode of the current block is a skip encoding mode when skip_flag of the received bitstream is 1.

The motion information encoding mode determination module 242 determines that the motion information encoding mode of the current block is a merge mode when skip_flag of the received bitstream is 0 and the motion information received from the de-multiplexer 241 has a merge index only.

The motion information encoding mode determination module 242 determines that the motion information encoding mode of the current block is an AMVP mode when skip_flag of the received bitstream is 0 and the motion information received from the de-multiplexer 241 has a reference picture index, a differential motion vector and an AMVP index.

The merge mode motion information decoding module 243 is activated when the motion information encoding mode determination module 242 determines that the motion information encoding mode of the current block is the skip or merge mode.

The AMVP mode motion information decoding module 244 is activated when the motion information encoding mode determination module 242 determines that the motion information encoding mode of the current block is the AMVP mode.

The prediction block generation module 245 generates a prediction block of the current block using the motion information reconstructed by the merge mode motion information decoding module 243 or the AMVP mode motion information decoding module 244.

When a motion vector is an integer unit, the prediction block of the current block is generated by copying a block corresponding to a position represented by the motion vector in a picture indicated by a reference picture index.

When the motion vector is not an integer unit, however, pixels of the prediction block are generated from integer pixels in the picture indicated by the reference picture index. Here, in a luma pixel, a predictive pixel may be generated using an 8-tap interpolation filter. In a chroma pixel, a predictive pixel may be generated using a 4-tap interpolation filter.

The residual block decoding module 246 entropy-decodes the residual signals. Further, the residual block decoding module 246 inversely scans the entropy-decoded coefficients to generate a 2D block of quantized coefficients. Different types of inverse scanning may be used depending on entropy decoding methods.

That is, different inverse scanning methods may be used for the inter predicted residual signals depending on CABAC-based decoding and CAVLC-based decoding. For example, diagonal raster inverse scanning may be available for CABAC-based decoding, while zigzag inverse scanning may be available for CAVLC-based decoding.

Further, different types of inverse scanning may be used depending on a size of the prediction block.

The residual block decoding module 246 dequantizes the block of generated coefficients using a dequantization matrix. A quantization parameter is reconstructed to derive the quantization matrix. A quantization step size is reconstructed by each CU of a predetermined size or larger.

The predetermined size may be 8×8 or 16×16. Thus, when the size of the current CU is smaller than the predetermined size, only a quantization parameter of a first CU in encoding order among a plurality of CUs smaller than the predetermined size is encoded, without necessarily encoding quantization parameters of remaining CUs since the quantization parameters of the remaining CUs are the same as the parameter.

To reconstruct the quantization parameter determined by the CU of the predetermined size or larger, a quantization parameter of a neighboring CU to the current CU is used. A first effective quantization parameter may be determined as a quantization parameter predictor of the current CU by retrieving a left CU and an upper CU of the current CU in order.

Alternatively, a first effective quantization parameter may be determined as the quantization parameter predictor by retrieving the left CU and a CU right before the current CU in encoding order. The quantization parameter of the current CU is reconstructed using the determined quantization parameter predictor and a differential quantization parameter.

The residual block decoding module 260 inverse-transforms the dequantized coefficient block to reconstruct a residual block.

The reconstruct block generation module 270 adds the prediction block generated by the prediction block generation module 250 and the residual block generated by the residual block decoding module 260 to generate a reconstructed block.

Hereinafter, a process of reconstructing a current block through intra prediction will be described with reference to FIG. 3.

First, an intra prediction mode of the current block is decoded from a received bitstream. To this end, the entropy decoding module 210 reconstructs a first intra prediction mode index of the current block by referring to a plurality of intra prediction mode tables.

The plurality of intra prediction mode tables may be shared between the encoding apparatus and the decoding apparatus, one of which may be selected for use based on distribution of intra prediction modes of a plurality of blocks adjacent to the current block.

In one exemplary embodiment, when a left block and an upper block of the current block have the same intra prediction mode, the first intra prediction mode index of the current block may be reconstructed by applying a first intra prediction mode table. When the left block and the upper block have different intra prediction modes, the first intra prediction mode index of the current block may be reconstructed by applying a second intra prediction mode table.

Alternatively, when both the upper block and the left block of the current block have directional intra prediction modes and a direction of the intra prediction mode of the upper block and a direction of the intra prediction mode of the left block form a predetermined angle or smaller, the first intra prediction mode index of the current block may be reconstructed by applying the first intra prediction mode table. When the angle is out of the predetermined angle, the first intra prediction mode index of the current block may be reconstructed by applying the second intra prediction mode table.

The entropy decoding module 210 transmits the reconstructed first intra prediction mode index of the current block to the intra prediction module 230.

The intra prediction module 230 receiving the first intra prediction mode index determines a maximum possible mode as the intra prediction mode of the current block when the index has a minimum value, that is, 0.

However, when the index has a value other than 0, the intra prediction module 230 compares an index representing the maximum possible mode of the current block with the first intra prediction mode index. As a result, when the first intra prediction mode index is not smaller than the index representing the maximum possible mode of the current block, an intra prediction mode corresponding to a second intra prediction mode index resulting from addition of 1 to the first intra prediction mode index is determined as the intra prediction mode of the current block. Otherwise, an intra prediction mode corresponding to the first intra prediction mode index is determined as the intra prediction mode of the current block.

Intra prediction modes allowable for the current block may include at least one non-directional mode and a plurality of directional modes.

The at least one non-directional mode may be a DC mode and/or a planar mode. Further, either of the DC mode and the planar mode may be adaptively included in a set of the allowable intra prediction modes.

To this end, a picture header or slice header may include information specifying non-directional mode included in the set of the allowable intra prediction mode.

Next, the intra prediction module 230 reads reference pixels from the picture storage module 260 and determines whether an unavailable reference pixel is included so as to generate an intra prediction block.

Such determination may be performed based on presence of reference pixels used to generate the intra prediction block using the decoded intra prediction mode of the current block.

When reference pixels need generating, the intra prediction module 230 generates reference pixels in unavailable positions using available reference pixels reconstructed in advance.

Definition of an unavailable reference pixel and a method of generating a reference pixel are the same as mentioned in the operations of the intra prediction module 150 illustrated in FIG. 1. Here, only the reference pixels used to generate the intra prediction block based on the decoded intra prediction mode of the current block may be selectively reconstructed.

Subsequently, the intra prediction module 230 determines whether to apply a filter to the reference pixels to generate the prediction block. That is, the intra prediction module 230 determines based on the decoded intra prediction mode and a size of the current prediction block whether to apply filtering on the reference pixels so as to generate the intra prediction block of the current block.

Blocking artifacts become serious with an increasing size of a block, and accordingly a greater number of prediction modes of filtering the reference pixels may be used as the size of the block increases. However, when the block is larger than a predetermined size, which may be considered as a flat area, the reference pixels may not be subjected to filtering in order to reduce complexity.

When it is determined that filtering is needed for the reference pixels, the reference pixels are filtered using a filter.

At least two filters may be adaptively applied depending on unevenness between the reference pixels. Filter coefficients of the filters are preferably symmetrical.

Further, the at least two filters may be adaptively applied depending on the size of the current block. That is, in using the filters, a filter with a narrow bandwidth may be applied to a block of a small size, while a filter with a broad bandwidth may be applied to a block of a large size.

In the DC mode, the prediction block is generated using an average value of the reference pixels, and thus filtering may not be needed. That is, when a filter is applied, unnecessary operations increases.

In the vertical mode in which the video has vertical correlation, no filtering may be needed for the reference pixels. In the horizontal mode in which the video has horizontal correlation, no filtering may be needed for the reference pixels.

Since application of filtering is associated with the intra prediction mode of the current block, the reference pixels may be adaptively filtered based on the intra prediction mode of the current block and the size of the prediction block.

Next, the prediction block is generated using the reference pixels or filtered reference pixels according to the reconstructed intra prediction mode. The prediction block is generated in the same manner as in the encoding apparatus, and thus description thereof is omitted herein. In the planar mode, the prediction block is also generated in the same manner as in the encoding apparatus, and thus description thereof is omitted herein.

Subsequently, the intra prediction module 230 determines whether to filter the generated prediction block. Determining whether to perform filtering may be carried out using information included in the slice header or a CU header. Further, determining whether to perform filtering may be carried out based on the intra prediction mode of the current block.

When the intra prediction module 230 determines to filter the generated prediction block, the prediction block is filtered. Specifically, the intra prediction module 230 filters a pixel in a particular position of the generated prediction block using the available reference pixels adjacent to the current block, thereby generating a new pixel.

Filtering a pixel may be applied when generating the prediction block. For example, in the DC mode, a predictive pixel adjoining a reference pixel among predictive pixels is filtered using the reference pixel adjoining the predictive pixel.

Thus, the predictive pixel is filtered using one or two reference pixels depending on a position of the predictive pixel. In the DC mode, filtering a predictive pixel may be applied to a prediction block of any size. In the vertical mode, predictive pixels adjoining a left reference pixel among predictive pixels of the prediction block may be changed using reference pixels other than an upper pixel used to generate the prediction block.

Likewise, in the horizontal mode, predictive pixels adjoining the upper reference pixel among the predictive pixels may be changed using reference pixels other than the left pixel used to generate the prediction block.

In this way, the current block is reconstructed using the reconstructed prediction block of the current block and the decoded residual block of the current block.

In one exemplary embodiment of the present invention, a video bitstream is a unit of storing encoded data of one picture and may include a parameter set (PS) and slice data.

A PS is divided into a picture parameter set (PPS) as data corresponding to a head of each picture and a sequent parameter set (SPS). The PPS and SPS may include initialization information needed to initialize each coding.

An SPS may include common reference information for decoding all pictures encoded into a random access unit (RAU), such as a profile, a maximum number of available pictures for reference and a picture size, which may be configured as in Tables 1 and 2.

TABLE 1

| | Descriptor |
|---|---|
| seq_parameter_set_rbsp( ) { | |
| sps_video_parameter_set_id | u(4) |
| sps_max_sub_layers_minus1 | u(3) |
| sps_temporal_id_nesting_flag | u(1) |
| profile_tier_level( sps_max_sub_layers_minus1 ) | |
| sps_seq_parameter_set_id | ue(v) |
| chroma_format_idc | ue(v) |
| if( chroma_format_idc = = 3 ) | |
| separate_colour_plane_flag | u(1) |
| pic_width_in_luma_samples | ue(v) |
| pic_height_in_luma_samples | ue(v) |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| bit_depth_luma_minus8 | ue(v) |
| bit_depth_chroma_minus8 | ue(v) |
| log2_max_pic_order_cnt_lsb_minus4 | ue(v) |
| sps_sub_layer_ordering_info_present_flag | u(1) |
| for( i = ( sps_sub_layer_ordering_info_present_flag ? 0 : | |
| sps_max_sub_layers_minus1 ); | |
| i <= sps_max_sub_layers_minus1; i++ ) { | |
| sps_max_dec_pic_buffering_minus1[ i ] | ue(v) |
| sps_max_num_reorder_pics[ i ] | ue(v) |
| sps_max_latency_increase_plus1[ i ] | ue(v) |
| } | |
| log2_min_luma_coding_block_size_minus3 | ue(v) |
| log2_diff_max_min_luma_coding_block_size | ue(v) |
| log2_min_transform_block_size_minus2 | ue(v) |
| log2_diff_max_min_luma_transform_block_size | ue(v) |
| max_transform_hierarchy_depth_inter | ue(v) |
| max_transform_hierarchy_depth_intra | ue(v) |
| scaling_list_enabled_flag | u(1) |

TABLE 2

| | |
|---|---|
| if( scaling_list_enabled_flag ) { | |
| sps_scaling_list_data_present_flag | u(1) |
| if( sps_scaling_list_data_present_flag ) | |
| scaling_list_data( ) | |
| } | |
| amp_enabled_flag | u(1) |
| sample_adaptive_offset_enabled_flag | u(1) |
| pcm_enabled_flag | u(1) |
| if( pcm_enabled_flag ) { | |
| pcm_sample_bit_depth_luma_minus1 | u(4) |
| pcm_sample_bit_depth_chroma_minus1 | u(4) |
| log2_min_pcm_luma_coding_block_size_minus3 | ue(v) |
| log2_diff_max_min_pcm_luma_coding_block_size | ue(v) |
| pcm_loop_filter_disabled_flag | u(1) |
| } | |
| num_short_term_ref_pic_sets | ue(v) |
| for( i = 0; i < num_short_term_ref_pic_sets; i++) | |
| st_ref_pic_set( i ) | |
| long_term_ref_pics_present_flag | u(1) |
| if( long_term_ref_pics_present_flag ) { | |
| num_long_term_ref_pics_sps | ue(v) |
| for( i = 0; i < num_long_term_ref_pics_sps; i++ ) { | |
| lt_ref_pic_poc_lsb_sps[ i ] | u(v) |
| used_by_curr_pic_lt_sps_flag[ i ] | u(1) |
| } | |
| } | |
| sps_temporal_mvp_enabled_flag | u(1) |
| strong_intra_smoothing_enabled_flag | u(1) |
| vui_parameters_present_flag | u(1) |
| if( vui_parameters_present_flag ) | |
| vui_parameters( ) | |
| sps_extension_flag | u(1) |
| if( sps_extension_flag ) | |
| while( more_rbsp_data( ) ) | |
| sps_extension_data_flag | u(1) |
| rbsp_trailing_bits( ) | |
| } | |

A PPS may include reference information for decoding each picture encoded into an RAU, such as a VLC type, an initial value of quantization and a plurality of reference pictures, which may be configured as in Tables 3 and 4.

TABLE 3

| | Descriptor |
|---|---|
| pic_parameter_set_rbsp( ) { | |
| pps_pic_parameter_set_id | ue(v) |
| pps_seq_parameter_set_id | ue(v) |
| dependent_slice_segments_enabled_flag | u(1) |
| output_flag_present_flag | u(1) |
| num_extra_slice_header_bits | u(3) |
| sign_data_hiding_enabled_flag | u(1) |
| cabac_init_present_flag | u(1) |
| num_ref_idx_l0_default_active_minus1 | ue(v) |
| num_ref_idx_l1_default_active_minus1 | ue(v) |
| init_qp_minus26 | se(v) |
| constrained_intra_pred_flag | u(1) |
| transform_skip_enabled_flag | u(1) |
| cu_qp_delta_enabled_flag | u(1) |
| if( cu_qp_delta_enabled_flag ) | |
| diff_cu_qp_delta_depth | ue(v) |
| pps_cb_qp_offset | se(v) |
| pps_cr_qp_offset | se(v) |
| pps_slice_chroma_qp_offsets_present_flag | u(1) |
| weighted_pred_flag | u(1) |
| weighted_bipred_flag | u(1) |
| transquant_bypass_enabled_flag | u(1) |
| tiles_enabled_flag | u(1) |
| entropy_coding_sync_enabled_flag | u(1) |
| if( tiles_enabled_flag ) { | |
| num_tile_columns_minus1 | ue(v) |
| num_tile_rows_minus1 | ue(v) |
| uniform_spacing_flag | u(1) |
| if( !uniform_spacing_flag ) { | |
| for( i = 0; i < num_tile_columns_minus1; i++ ) | |
| column_width_minus1[ i ] | ue(v) |
| for( i = 0; i < num_tile_rows_minus1; i++ ) | |
| row_height_minus1[ i ] | ue(v) |
| } | |
| loop_filter_across_tiles_enabled_flag | u(1) |
| } | |

TABLE 4

| | |
|---|---|
| loop_filter_across_slices_enabled_flag | u(1) |
| deblocking_filter_control_present_flag | u(1) |
| if( deblocking_filter_control_present_flag ) { | |
| deblocking_filter_override_enabled_flag | u(1) |
| pps_deblocking_filter_disabled_flag | u(1) |
| if( !pps_deblocking_filter_disabled_flag ) { | |
| pps_beta_offset_div2 | se(v) |
| pps_tc_offset_div2 | se(v) |
| } | |
| } | |
| pps_scaling_list_data_present_flag | u(1) |
| if( pps_scaling_list_data_present_flag ) | |
| scaling_list_data( ) | |
| lists_modification_present_flag | u(1) |
| log2_parallel_merge_level_minus2 | ue(v) |
| slice_segment_header_extension_present_flag | u(1) |
| pps_extension_flag | u(1) |
| if( pps_extension_flag ) | |
| while( more_rbsp_data( ) ) | |
| pps_extension_data_flag | u(1) |
| rbsp_trailing_bits( ) | |
| } | |

Meanwhile, a slice header (SH) may include information on a slice in coding based on a slice unit, which may be configured as in Tables 5 to 7.

TABLE 5

| | Descriptor |
|---|---|
| slice_segment_header( ) { | |
| first_slice_segment_in_pic_flag | u(1) |
| if( nal_unit_type >= 16 && | |
| nal_unit_type <= 23 )/* IRAP picture */ | |
| no_output_of_prior_pics_flag | u(1) |
| slice_pic_parameter_set_id | ue(v) |
| if( !first_slice_segment_in_pic_flag ) { | |
| if( dependent_slice_segments_enabled_flag ) | |
| dependent_slice_segment_flag | u(1) |
| slice_segment_address | u(v) |
| } | |
| if( !dependent_slice_segment_flag) { | |
| for( i = 0; i < num_extra_slice_header_bits; i++ ) | |
| slice_reserved_flag[i] | u(1) |
| slice_type | ue(v) |
| if( output_flag_present_flag ) | |
| pic_output_flag | u(1) |
| if( separate_colour_plane_flag = = 1 ) | |
| colour_plane_id | u(2) |
| if( nal_unit_type != IDR_W_RADL && | |
| nal_unit_type != IDR_N_LP ) { | |
| /* Not an IDR picture */ | |
| slice_pic_order_cnt_lsb | u(v) |
| short_term_ref_pic_set_sps_flag | u(1) |
| if( !short_term_ref_pic_set_sps_flag ) | |
| short_term_ref_pic_set | |
| (num_short_term_ref_pic_sets ) | |
| else if( num_short_term_ref_pic_sets > 1 ) | |
| short_term_ref_pic_set_idx | u(v) |
| if( long_term_ref_pics_present_flag ) { | |
| if( num_long_term_ref_pics_sps > 0 ) | |
| num_long_term_sps | ue(v) |
| num_long_term_pics | ue(v) |
| for( i = 0; i < num_long_term_sps + | |
| num_long_term_pics; i++ ){ | |
| if( i < num_long_term_sps ) { | |
| if( num_long_term_ref_pics_sps > 1 ) | |
| lt_idx_sps[ i ] | u(v) |
| } else { | |
| poc_lsb_lt[ i ] | u(v) |
| used_by_curr_pic_lt_flag[ i ] | u(1) |
| } | |
| delta_poc_msb_present_flag[ i ] | u(1) |
| if( delta_poc_msb_present_flag[ i ]) | |
| delta_poc_msb_cycle_lt[ i ] | ue(v) |
| } | |
| } | |
| if( sps_temporal_mvp_enabled_flag ) | |
| slice_temporal_mvp_enabled_flag | u(1) |

TABLE 6

| | |
|---|---|
| } | |
| if( sample_adaptive_offset_enabled_flag { | |
| slice_sao_luma_flag | u(1) |
| slice_sao_chroma_flag | u(1) |
| } | |
| if( slice_type = = P \| \| slice_type = = B) { | |
| num_ref_idx_active_override_flag | u(1) |
| if( num_ref_idx_active_override_flag ) { | |
| num_ref_idx_l0_active_minus1 | ue(v) |
| if( slice_type = = B ) | |
| num_ref_idx_l1_active_minus1 | ue(v) |
| } | |
| if( lists_modification_present_flag && NumPicTotalCurr > 1) | |
| ref_pic_lists_modification( ) | |
| if( slice_type = = B ) | |
| mvd_l1_zero_flag | u(1) |
| if( cabac_init_present_flag ) | |
| cabac_init_flag | u(1) |
| if( slice_temporal_mvp_enabled_flag ) { | |
| if( slice_type = = B ) | |
| collocated_from_l0_flag | u(1) |
| if( ( collocated_from_l0_flag && num_ref_idx_l0_active_minus1 > 0) | |
| \| \| | |
| ( !collocated_from_l0_flag && num_ref_idx_l1_active_minus1 > 0 ) ) | |
| collocated_ref_idx | ue(v) |
| } | |
| if( ( weighted_pred_flag && slice_type = = P) \| \| | |
| ( weighted_bipred_flag && slice_type = = B ) ) | |
| pred_weight_table( ) | |
| five_minus_max_num_merge_cand | ue(v) |
| } | |
| slice_qp_delta | se(v) |
| if( pps_slice_chroma_qp_offsets_present_flag ) { | |
| slice_cb_qp_offset | se(v) |
| slice_cr_qp_offset | se(v) |
| } | |
| if( deblocking_filter_override_enabled_flag ) | |
| deblocking_filter_override_flag | u(1) |
| if( deblocking_filter_override_flag ) { | |
| slice_deblocking_filter_disabled_flag | u(1) |
| if( !slice_deblocking_filter_disabled_flag ) { | |
| slice_beta_offset_div2 | se(v) |
| slice_tc_offset_div2 | se(v) |
| } | |
| } | |
| if( pps_loop_filter_across_slices_enabled_flag && | |
| ( slice_sao_luma_flag \| \| slice_sao_chroma_flag \| \| | |
| !slice_deblocking_filter_disabled_flag ) ) | |
| slice_loop_filter_across_slices_enabled_flag | u(1) |
| } | |
| if( tiles_enabled_flag \| \| entropy_coding_sync_enabled_flag ) { | |

TABLE 7

| | |
|---|---|
| num_entry_point_offsets | ue(v) |
| if( num_entry_point_offsets > 0 ) { | |
| offset_len_minus1 | ue(v) |
| for( i = 0; i < num_entry_point_offsets; i++) | |
| entry_point_offset_minus1[ i ] | u(v) |
| } | |
| } | |
| if( slice_segment_header_extension_present_flag ) { | |
| slice_segment_header_extension_length | ue(v) |
| for( i = 0; i < slice_segment_header_extension_length; i++) | |
| slice_segment_header_extension_data_byte[ i ] | u(8) |
| } | |
| byte_alignment( ) | |
| } | |

Hereinafter, a configuration for performing video encoding and video decoding in a scalable manner using processing using a plurality of processing units will be described in detail.

A video processing apparatus according to an exemplary embodiment of the present invention includes a video central processing unit to communicate with a host and to parse parameter information or slice header information from video data input from the host, and a plurality of video processing units to process a video based on the parsed information according to control by the video central processing unit, wherein the video central processing unit determines an entry point of a video bitstream to be allocated to each of the video processing units in view of a number of pixels to be processed by each video processing unit.

The video central processing unit may determine a plurality of video processing units to be used for processing the video using level information included in an SPS of the parsed parameter information.

The video central processing unit may determine the entry point of the video bitstream to be allocated to each of the video processing units so that the number of pixels to be processed by each of the determined video processing units is as equal as possible.

Each of the video processing units may include a first video processing unit communicating with the video central processing unit to perform entropy coding on the video data and a second video processing unit to process the entropy-coded video data into a coding unit.

A video processing method of a video processing apparatus including a video central processing unit and a plurality of video processing units according to an exemplary embodiment of the present invention includes parsing, by the video central processing unit, parameter information or slice header information from video data input from a host while communicating with the host, determining, by the video central processing unit, an entry point of a video bitstream to be allocated to each of the video processing units in view of a number of pixels to be processed by each video processing units, and processing, by the video processing units, a video based on the parsed information according to control by the video central processing unit.

The video processing method may further include determining, by the video central processing unit, a plurality of video processing units to be used for processing the video using level information included in an SPS of the parsed parameter information.

The determining of the staring position of the video stream may include determining, by the video central processing unit, the entry point of the video bitstream to be allocated to each of the video processing units so that the number of pixels to be processed by each of the determined video processing units is as equal as possible.

Each of the video processing units may include a first video processing unit and a second video processing unit, wherein the first video processing unit communicates with the video central processing unit to perform entropy coding on the video data and the second video processing unit processes the entropy-coded video data into a coding unit.

Here, the video processing apparatus may be referred to as a VPU 300, the video central processing unit as a V-CPU 310, and the video processing units as a V-Core 320. Further, the first video unit may be referred to as a BPU 321 and the second video processing unit as a VCE 322.

Meanwhile, the video processing apparatus may include both the video encoding apparatus and the video decoding apparatus. The video encoding apparatus and the video decoding apparatus may be configured to perform opposite processes, as described above in FIGS. 1 to 4, and thus the following description will be made on the video decoding apparatus for convenience. Alternatively, the video processing apparatus may be also configured as the video decoding apparatus which performs operations of the video decoding apparatus in reverse order, without being limited to the video decoding apparatus.

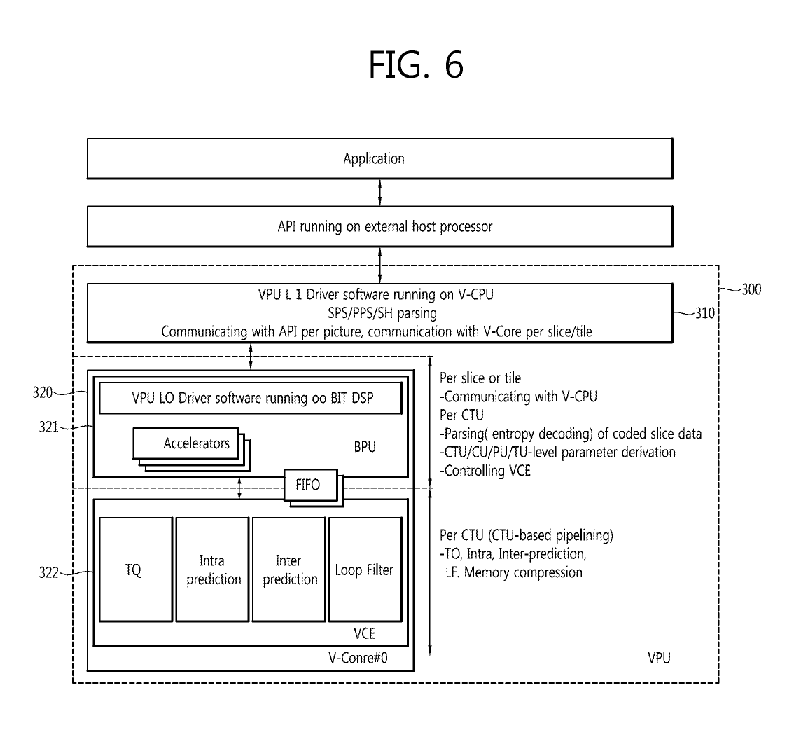

FIG. 6 illustrates a layer structure of a video decoding apparatus according to an exemplary embodiment of the present invention. Referring to FIG. 6, the video decoding apparatus may include a video processing unit (VPU) 300 which performs a video decoding function, wherein the VPU 300 may include a V-CPU 310, a BPU 321 and a VCE 322. Here, the BPU 321 and the VCE 322 may be combined into a V-Core 320.

The VPU 300 according to the present embodiment may include one V-CPU 310 and a plurality of V-Cores 320 (hereinafter, “multi V-Cores”). Numbers of V-CPUs and V-Cores may change depending on a configuration of the VPU 300, without being limited to the foregoing example.

The V-CPU 310 controls overall operations of the VPU 300. In particular, the V-CPU 310 may parse a video parameter set (VPS), an SPS, a PPS and an SH from a received video bitstream. The V-CPU 310 may control the overall operations of the VPU 300 based on the parsed information.

For instance, the V-CPU 310 may determine a number of V-Cores 320 to be used for data parallel processing based on the parsed information. As a result, when it is determined that a plurality of V-Cores 320 is needed for data parallel processing, the V-CPU 310 may determine a region that each V-Core 320 of the multi V-Cores 320 is to process.

Further, the V-CPU 310 may determine an entry point of the bitstream with respect to a region to be allocated to each V-Core 320.

Also, the V-CPU 310 may allocate a boundary region in one picture generated by decoding using the multi V-Cores 320 to the multi V-Cores 320.

Here, the V-CPU 310 may communicate with an application programming interface (API) by a picture and communicate with the V-Cores 320 by a slice/tile.

The V-Cores 320 perform decoding and boundary processing according to control by the V-CPU 310. For instance, the V-Cores 320 may decode an allocated region according to control by the V-CPU 310. Also, the V-Cores 320 may perform boundary processing on an allocated boundary region according to control by the V-CPU 310.

Here, the V-Cores 320 may include the BPU 321 and the VCE 322.

The BPU 321 entropy-decodes data of an allocated region (slice or tile). That is, the PBU 321 may perform a function of the entropy decoding module 210 and derive CTU/CU/PU/TU-level parameters. In addition, the BPU 321 may control the VCE 322.

Here, the BPU 321 may communicate with the V-CPU 310 by a slice or tile and communicate with the VCE 322 by a CTU.

The VCE 322 receives the derived parameter from the BPU 321 to perform transform/quantization (TQ), intra prediction, inter prediction, loop filtering (LF) and memory compression. That is, the VCE 322 may perform functions of the dequantization/inverse transform module 220, the deblocking filter 250, the intra prediction module 230 and the motion compensation prediction module 240.

Here, the VCE 322 may perform data processing on an allocated region using CTU-based pipelining.

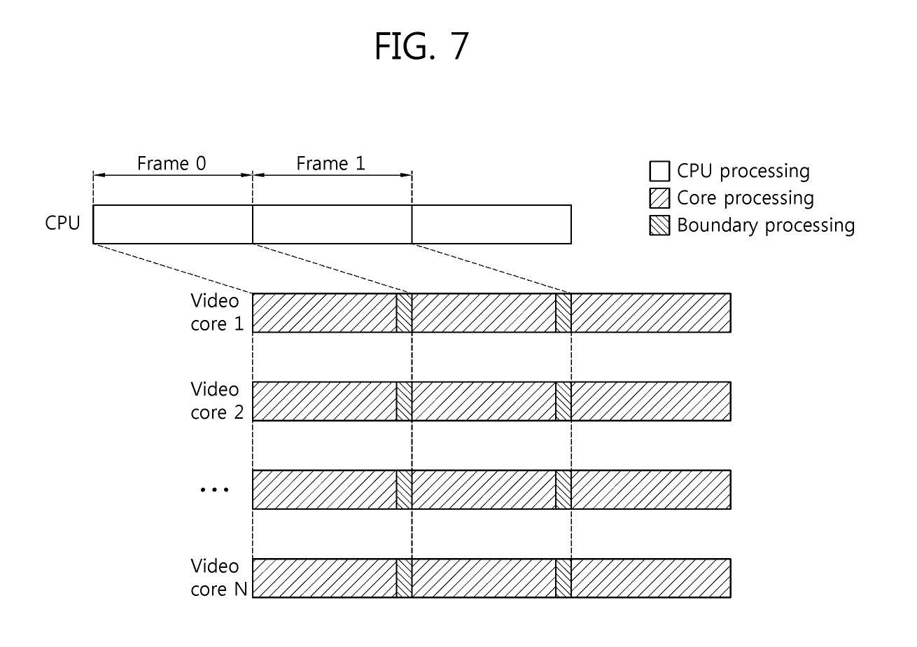

FIG. 7 is a timing view illustrating a video decoding operation of the VPU according to an exemplary embodiment of the present invention. Referring to FIG. 7, the V-CPU 310 allocates regions of each picture (frame) to the multi V-Cores 320, and the multi V-Cores 320 may perform decoding (core processing) and boundary processing.

Hereinafter, operations of the V-CPU 310 will be described in detail.

The V-CPU 310 may perform an interface operation with a host processor.

The V-CPU 310 may parse a VPS/SPS/PPS/SH from a received video bitstream.

The V-CPU 310 may transmit information needed for the V-Core 320 to decode a slice/tile using the parsed information. Here, the needed information may include a picture parameter data structure and a slice control data structure.

The picture parameter data structure may include information as follows.

For example, the picture parameter data structure may include information included in a sequence/picture header, such as a picture size, a scaling list, a CTU, minimum/maximum CU sizes and minimum/maximum TU sizes, and positions (addresses) of buffers needed for frame decoding.

The picture parameter data structure may be set once while decoding one picture.

The slice control data structure may include information as follows.

For example, the slice control data structure may include information included in a slice header, such as a slice type, slice/tile information, a reference picture list and a weighted prediction parameter.

The slice control data structure may be set when a slice is changed. Inter-processor communication registers or a slice parameter buffer at an external memory of the V-Cores 320 may store N slice control data structures, and also store in advance a data structure not corresponding to a slice currently being decoded, if not full. In unit processing, N may be determined based on reported completion of processing from the V-Cores 320 to the V-CPU 310 whether after a pipe of the VCE 322 completely flushed (N=1) in processing a unit or maintained pipelining between a segment currently being processed and a next segment (N>1).

Here, information transmitted from the V-CPU 310 to the V-Cores 320 may be transmitted through the inter-processor communication registers of the V-Cores 320. The inter-processor communication registers may be configured as a register array (file) of a fixed size or an external memory. If the inter-processor communication registers are configured as an external memory, the V-CPU 310 may store information in the external memory and the BPU 321 may read information from the external memory.

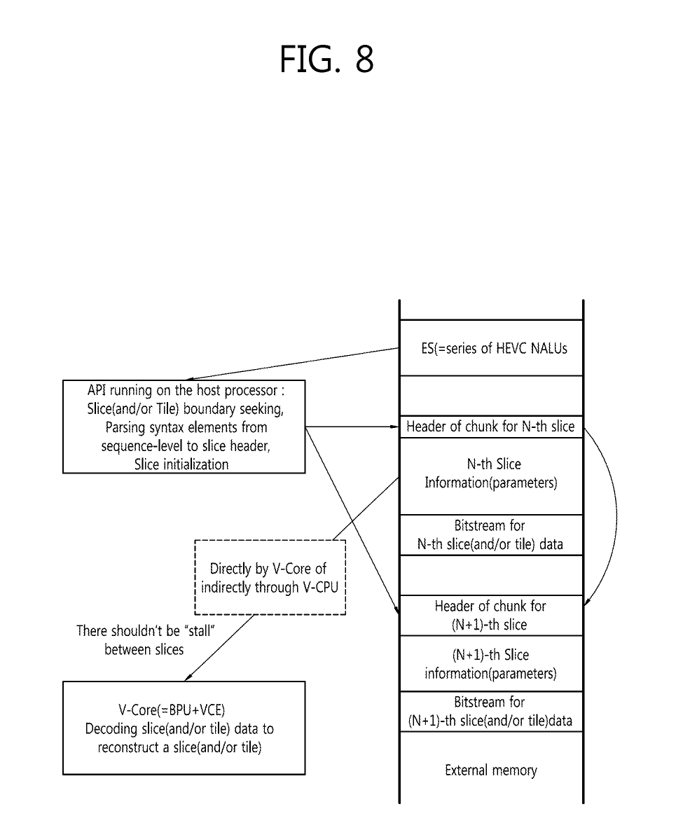

Meanwhile, even when the V-Cores 320 are able to store only one slice control data structure or any number of slice control data structures, the V-CPU 310 may need to continue to conduct SH decoding and parameter generation to prevent an idle state of the V-Core 320 between segments for a long time, as shown in FIG. 8.

One slice includes a plurality of tiles. When the tiles are processed in parallel by the multi V-Cores 320, the V-CPU 310 may transmit the same slice control data structure to the multi V-Cores 320.

Further, the V-CPU 310 may control synchronization of the multi V-Cores 320 for parallel data processing of the multi V-Cores 320.

The V-CPU 310 may process an exception which may occur in the V-Cores 320. For example, when the V-CPU 310 detects an error in decoding a parameter set, the BPU 321 of the V-Cores 320 detects an error in decoding slice data, or an allocated decoding time is over while decoding a frame, such as peripherals of the V-CPU 310 and the V-Cores 320 are stalled due to an unidentified error in the VPU 300 or a disorder of a system bus, the V-CPU 310 may deal with such problems.

The V-CPU 310 may report completion of frame decoding to the API when the VPU 300 finishes decoding a frame.

The V-CPU 310 may determine a number of V-Cores 320 to be used for parallel data processing based on the parsed information. If it is determined that a plurality of V-Cores 320 is necessary for parallel data processing, the V-CPU 310 may determine regions to be processed by each V-Core 320 of the multi V-Cores 320.

In addition, the V-CPU 310 may determine an entry point of the bitstream with respect to a region to be allocated to each V-Core 320.

Also, the V-CPU 310 may allocate a boundary region in one picture generated by decoding using the multi V-Cores 320 to the multi V-Cores 320.

Hereinafter, operations of the BPU 321 will be described in detail.

The BPU 321 may entropy-decode data of an allocated region (slice or tile). Since the SH is decoded by the V-CPU 310 and the needed information is received through the picture parameter data structure and the slice control data structure, the BPU 320 does not decode the SH.

The BPU 321 may derive CTU/CU/PU/TU-level parameters. The BPU 321 may transmit the derived parameters to the VCE 322.

Here, information commonly used for each block, such as a picture size and a segment offset/size, and CTU/CU/PU/TU parameters, coefficients and reference pixel data needed for decoding, other than source/destination addresses to DMAC, may be transmitted by the BPU 321 and the VCE 322 through FIFO. Here, segment-level parameters may be set in an internal register of the VCE 322, instead of in the FIFO.

The BPU 321 may function as a VCE controller which controls the VCE 322. The VCE controller may output picture_init and segment_init signals and a software reset that the BPU 321 is able to control by register setting, and sub-blocks of the VCE 322 may use these signals for control.

When the BPU 321 sets up picture/segment-level parameters in the VCE controller and issues a command to run a segment by register setting, decoding a set segment may be controlled by referring to fullness of a CU parameter FIFO and status information on the sub-blocks without communications with the BPU 321 until the segment is completely decoded.

The BPU 321 may process an exception which may occur in the BPU 321.

The BPU 321 may report completion of processing to the V-CPU 310 when processing a slice/tile segment is finished.

The VCE 322 may receive the derived parameter from the BPU 321 to perform transform/quantization (TQ), intra prediction, inter prediction, loop filtering (LF) and memory compression.

Here, the VCE 322 may perform data processing on an allocated region using CTU-based pipelining.

According to various embodiments of the present invention mentioned above, there is provided a V-CPU capable of separating header parsing and data processing and pipelining separated data processing to distribute operations to the multi V-Cores and synchronize the multi V-Cores.

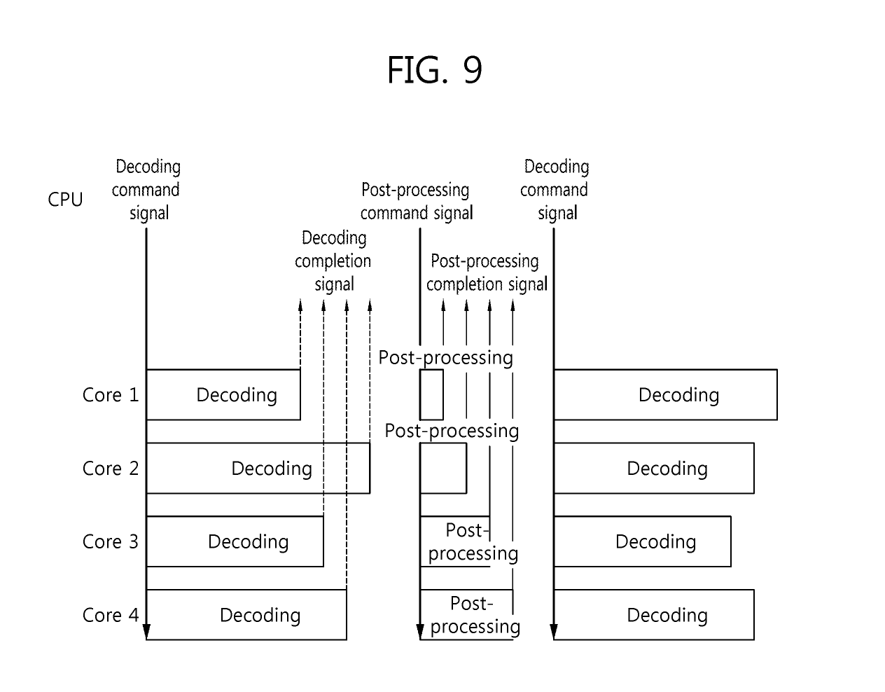

Hereinafter, a method of controlling synchronization of the multi V-Cores 320 for parallel data processing of the multi V-Cores 320 performed by the V-CPU 310 will be described in detail with reference to FIG. 9.

Referring to FIG. 9, the V-CPU 310 may transmit a decoding command signal to each of multi V-Cores 320 determined to be used for parallel data processing. Accordingly, each V-Core 320 may perform decoding, and transmit a decoding completion signal to the V-CPU 310 when decoding is finished.

When the decoding completion signals are received from all V-Cores 320 having received the decoding command signal, the V-CPU 310 may transmit a post-processing command, for example, a boundary processing command, to the multi V-Cores 320. Each V-Core 320 may perform post-processing, and transmit a post-processing completion signal to the V-CPU 310 after post-processing is finished.

When the post-processing completion signals are received from all V-Cores 320 having received the post-processing command signal, the V-CPU 310 may transmit a decoding command signal to each of the multi V-Cores 320 determined to be used. Accordingly, the V-CPU 310 may control synchronization of the multi V-Cores 320 for parallel data processing.

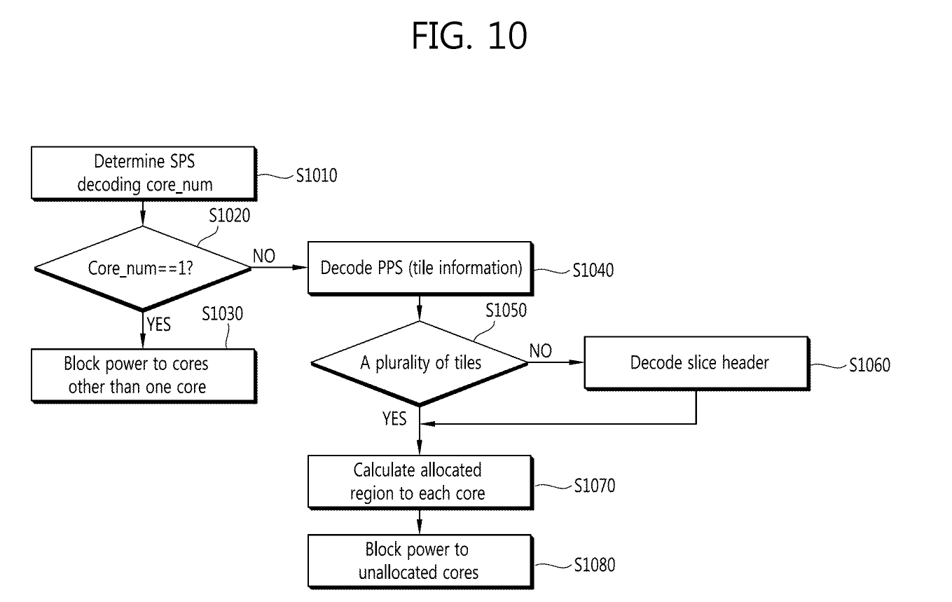

Hereinafter, a method of determining a number of V-Cores to be used for parallel data processing performed by the V-CPU 310 will be described in detail with reference to FIG. 10.

Referring to FIG. 10, the V-CPU determines core_num for SPS decoding (S1010). Here, core_num means a number of V-Cores to be used for real-time decoding. If core_num==1 (S1020), power to remaining cores is blocked except for one core (S1030). If core_num is not 1, a PPS decoding process is performed (S1040). If there is a plurality of tiles (S1050), the V-CPU calculates an allocated region for each V-Core (S1070). Subsequently, the V-CPU blocks power to unallocated V-Cores (S1080).

If there is a single tile (S1050), the V-CPU decodes a slice header (S1060). The V-CPU calculates an allocated region for each V-Core (S1070). Subsequently, the V-CPU blocks power to unallocated V-Cores (S1080).

In detail, the V-CPU 310 may parse an SPS to detect level information included in the parsed SPS. The V-CPU 310 may compare the detected level information with level information processible by V-Cores 320 to determine a number of V-Cores to be used for real-time decoding.

Here, the V-CPU 310 may use level information processible by the V-Cores 320 illustrated in Table 8.

TABLE 8

| | Max luma sample rate | Max bit rate MaxBR | | |
|---|---|---|---|---|
| | MaxLumaSr | (1000 bits/s) | | MinCompression |
| Level | (samples/sec) | Main tier | High tier | RatioMinCr |
| 1 | 552960 | 128 | — | 2 |
| 2 | 3686400 | 1500 | — | 2 |
| 2.1 | 7372800 | 3000 | — | 2 |
| 3 | 16588800 | 6000 | — | 2 |
| 3.1 | 33177600 | 10000 | — | 2 |
| 4 | 66846720 | 12000 | 30000 | 4 |
| 4.1 | 133693440 | 20000 | 50000 | 4 |
| 5 | 267386880 | 25000 | 100000 | 6 |
| 5.1 | 534773760 | 40000 | 160000 | 8 |
| 5.2 | 1069547520 | 60000 | 240000 | 8 |
| 6 | 1069547520 | 60000 | 240000 | 8 |
| 6.1 | 2139095040 | 120000 | 480000 | 8 |
| 6.2 | 4278190080 | 240000 | 800000 | 6 |

For example, if one V-Core 320 is capable of decoding level 5.0 and the level information on the bitstream is 5.0, the V-CPU 310 determines that one V-Core 320 is necessary. The V-CPU 310 may determine one V-CPU 310 to use.

Alternatively, when one V-core 320 is capable of decoding level 5.0 and the level information on the bitstream is 5.1, the V-CPU 310 determines that two V-Cores 320 are necessary.

If it is determined that two or more V-Cores 320 are necessary, the V-CPU 310 may determine, by parsing tile information of a PPS and an SH, which of the following three cases each frame corresponds to.

CASE 1) 1 tile, 1 slice

CASE 2) Multiple tile

CASE 3) 1 tile, multiple slice

If the bitstream includes a 1 tile or 1 slice (CASE 1), parallel processing is not possible and only one V-Core 320 may be used. In this case, the V-CPU 310 may determine one V-CPU 310 to use.

If the bitstream includes multiple tiles (CASE 2), the V-CPU 310 may determine a number of V-Cores 320 so that each V-Core 320 processes in parallel as close to the same number of pixels as possible. In this case, the V-CPU 310 determines a determined number of V-Cores 320 to use. The V-CPU 310 may allocate processing regions to the respective V-Cores 320 determined to process in parallel as close to the same number of pixels as possible.

If the bitstream includes a 1 tile and multiple slices (CASE 3), the V-CPU 310 may determine a number of V-Cores 320 so that each V-Core 320 processes in parallel as close to the same number of pixels as possible. In this case, the V-CPU 310 determines a determined number of V-Cores 320 to use. The V-CPU 310 may allocate processing regions to the respective V-Cores 320 determined to process in parallel as close to the same number of pixels as possible.

Meanwhile, power to a V-Core 320 determined not to be used may be blocked.

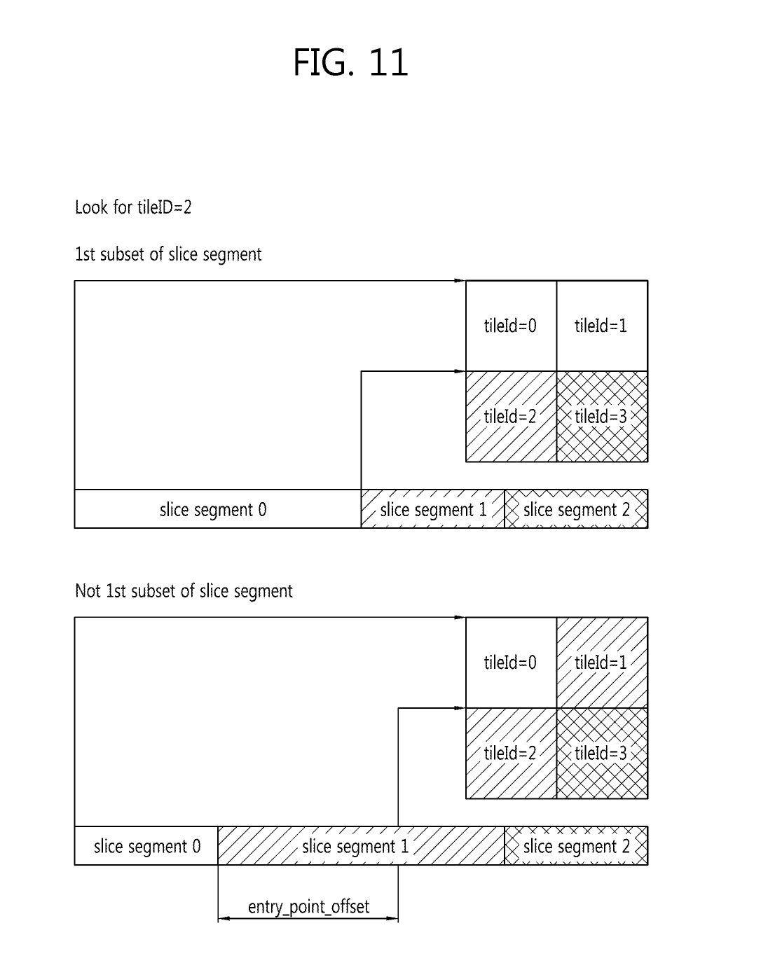

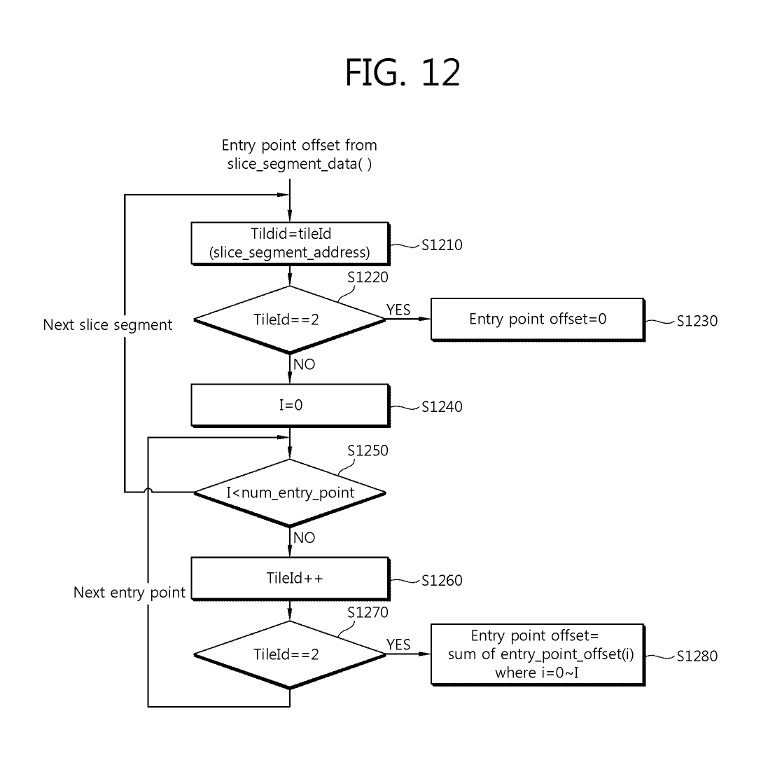

Hereinafter, a method of retrieving an entry point performed by the V-CPU 310 will be described in detail with reference to FIGS. 11 and 12.

<System Layer Presents Entry Point>

If a system presents a position of an entry point, the V-CPU 310 may conduct reverse seeking for parsing an SH, thereby retrieving a start code.

If a retrieved slice is a dependent slice, the V-CPU 310 may continue to conduct reverse seeking until a normal slice is retrieved.

The system presents a position of an NAL unit if the NAL unit is not a dependent slice.

<System does not Present Entry Point>

Since entry point information is absent in a picture level, the V-CPU 310 may parse all slice headers in a picture by a picture to retrieve an entry point. Here, entry point information is present at the end of the slice headers, and thus the V-CPU 310 may parse all syntaxes of the slice headers to find the entry point information.

In this case, since all slice headers in the picture are involved in parsing by a picture, when retrieving the entry point, the V-CPU 310 may store all slice headers in a memory of the V-CPU 310. Accordingly, when the V-cores 320 operate later, it may be unnecessary to iteratively parse slice headers. For example, the memory may need a memory size of about 300 bytes/slice*600 (MaxSlicesPerPicture of 6.2(max level))=180 KB to save all slice headers of a picture.

That is, a single core is sequentially decoded using one V-Core, and thus an entry point may not need to be retrieved in advance.

However, since a multi-core is decoded using a plurality of V-Cores, and thus it is necessary to retrieve entry points in advance for parallel decoding using the V-Cores.

Accordingly, in one exemplary embodiment of the present invention, the V-CPU may retrieve an entry point in advance to perform decoding using the multi V-Cores.

Meanwhile, FIGS. 11 and 12 illustrate an example of retrieving an entry point when the system layer does not present an entry point. FIG. 11 illustrates a method of retrieving an entry point of a tile in a non-square slice (Look for tileID=2) when all slices in a picture have a square shape (1st subset of slice segments) and when at least one of the slices in the picture does not have a square shape (Not 1st subset of slice segments).

Referring to FIG. 12, TileId is defined as TileId[slice_segment_address] (S1210). When TileId is 2 (S1220), an entry point offset is 0 (S1230). If TileId is not 2 (S1220), I=0 (S1240). When I<num_entry_point (S1250), a next slice segment is input to entry point offset from slice_segment_data( )

If it is not satisfied I<num_entry_point (S1250), a TileID++ operation is performed (S1260). Accordingly, if TileId is 2 (S1270), the entry point offset is Sum of entry)point_offset[i](i=0˜I) (S1280). If TileId is not 2 (S1270), a Next entry_point is input to I<num_entry_point (S1250).

<All Slices in Picture have Square Shape (1St Subset of Slice Segments)>

Applying an algorithm illustrated in FIG. 12, if tileID=2 (S1220), the entry point offset is 0 (S1230), and thus an entry point with respect to tileID=2 may be retrieved.

<At Least One of Slices in Picture does not have Square Shape (not 1St Subset of Slice Segments)>

Applying the algorithm illustrated in FIG. 12, if tileID=2, entry point offset=sum of entry point offset[i] (S1230), and thus an entry point with respect to tileID=2 may be retrieved.

Hereinafter, a method of the V-CPU 310 allocating entry points so that a number of pixels to be allocated to each of the multi V-Cores 320 is as equal as possible will be described in detail with reference to Table 9.

As shown above in Table 8 and FIG. 10, the V-CPU 310 may determine to use two or more V-Cores 320 for parallel processing and select V-Cores 320 to use. In this case, the V-CPU 310 may allocate entry points retrieved by FIGS. 11 and 12 to the selected V-Cores 320 so that a number of pixels to be allocated to each of the V-Cores 320 is as equal as possible.

First, a method of determining regions to be allocated to the respective multi V-Cores 320 may be carried out by an algorithm illustrated in Table 9.

In Table 9, ctb_num_in_pic may represent a number of CTBs in a picture, and ctb_num_in_segment[ ] may represents a number of CTBs in each tile or slice. According to Table 9, an allocated region to each V-Core 320 may be determined (core_start_addr[core_id]).

```
TABLE 9
segment_id=0;//tile or slice id
core_end_addr=0;
for(core_id=0;
core_id<core_num&&core_end_addr<ctb_num_in_pic; core_id++)
{
      core_start_addr[core_id]=core_end_addr
      core_end_addr+=ctb_num_in_segment[segment_id]
      while(core_end_addr<ctb_num_in_pic)
      {
            segment_id++;
      if(core_end_addr+ctb_num_in_segment[segment_id]>
floor(ctb_num_in_pic/core_num))
            break;
            core_end_addr+=ctb_num_in_segment[segment_id];
      }
}
```

The V-CPU 310 to may properly allocate the entry points to the respective V-Cores 320 using entry point information of slice_ddress and a slice header so that the number of pixels to be allocated to each V-Core 320 is as equal as possible.

The aforementioned methods according to the present invention can be written as computer programs to be implemented in a computer and be recorded in a computer readable recording medium. Examples of the computer readable recording medium include read-only memory (ROM), random-access memory (RAM), CD-ROMs, magnetic tapes, floppy disks, optical data storage devices, and carrier waves, such as data transmission through the Internet.

The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While exemplary embodiments of the present invention have been shown and described, the present invention is not limited to the described exemplary embodiments. Instead, it would be appreciated by those skilled in the art that various changes and modifications may be made to these exemplary embodiments without departing from the spirit and scope of the invention as defined by the appended claims, and these changes and modifications are not construed as being separated from the technical idea and prospects of the present invention.

1. A video decoding apparatus comprising:
a video central processing unit to communicate with a host and to parse parameter information or slice header information from video data input from the host; and
a plurality of video processing units to process a video based on the parsed information according to control by the central video processing unit,
wherein the video central processing unit determines an entry point of a video bitstream to be allocated to each of the video processing units in view of a number of pixels to be processed by each video processing unit.

2. The video decoding apparatus of claim 1, wherein the video central processing unit determines a number of video processing units to be used for processing the video using level information comprised in a sequence parameter set (SPS) of the parsed parameter information.

3. The video decoding apparatus of claim 2, wherein the level information comprises at least one of a sample rate and a bit rate of the video data.

4. The video decoding apparatus of claim 2, wherein the video central processing unit determines the entry point of the video bitstream to be allocated to each of the video processing units so that a difference between numbers of pixels to be processed by the determined video processing units is minimized.

5. The video decoding apparatus of claim 1, wherein each of the video processing units comprises a first processing unit communicating with the video central processing unit to perform entropy coding on the video data and a second processing unit to process the entropy-coded video data into a coding unit.

6. A video decoding method of a video decoding apparatus comprising a video central processing unit and a plurality of video processing units to process a video according to control by the video central processing unit, the video central processing unit processing the video, the video decoding method comprising:
parsing, by the video central processing unit, parameter information or slice header information from video data input from a host while communicating with the host; and
determining, by the video central processing unit, an entry point of a video bitstream to be allocated to each of the video processing units in view of a number of pixels to be processed by each video processing units.

7. The video decoding method of claim 6, further comprising determining a plurality of video processing units to be used for processing the video using level information comprised in an sequence parameter set (SPS) of the parsed parameter information.

8. The video decoding method of claim 7, wherein the level information comprises at least one of a sample rate and a bit rate of the video data.

9. The video decoding method of claim 7, wherein the determining of the entry point determines the entry point of the video bitstream to be allocated to each of the video processing units so that a difference between numbers of pixels to be processed by the determined video processing units is minimized.

10. The video decoding method of claim 6, wherein each of the video processing units comprises a first processing unit and a second processing unit, and the video decoding method further comprises communicating by the first processing unit with the video central processing unit to perform entropy coding on the video data and processing by the second processing unit the entropy-coded video data into a coding unit.

11. A video encoding apparatus comprising:
a video central processing unit to communicate with a host and to parse parameter information or slice header information from video data input from the host; and
a plurality of video processing units to process a video based on the parsed information according to control by the central video processing unit,
wherein the video central processing unit determines an entry point of a video bitstream to be allocated to each of the video processing units in view of a number of pixels to be processed by each video processing unit.

12. The video encoding apparatus of claim 11, wherein the video central processing unit determines a number of video processing units to be used for processing the video using level information comprised in a sequence parameter set (SPS) of the parsed parameter information.

13. The video encoding apparatus of claim 12, wherein the level information comprises at least one of a sample rate and a bit rate of the video data.

14. The video encoding apparatus of claim 12, wherein the video central processing unit determines the entry point of the video bitstream to be allocated to each of the video processing units so that a difference between numbers of pixels to be processed by the determined video processing units is minimized.

15. The video encoding apparatus of claim 11, wherein each of the video processing units comprises a first processing unit communicating with the video central processing unit to perform entropy coding on the video data and a second processing unit to process the entropy-coded video data into a coding unit.

16. A video encoding method of a video encoding apparatus comprising a video central processing unit and a plurality of video processing units to process a video according to control by the video central processing unit, the video central processing unit processing the video, the video encoding method comprising:
parsing, by the video central processing unit, parameter information or slice header information from video data input from a host while communicating with the host; and
determining, by the video central processing unit, an entry point of a video bitstream to be allocated to each of the video processing units in view of a number of pixels to be processed by each video processing units.

17. The video encoding method of claim 16, further comprising determining a plurality of video processing units to be used for processing the video using level information comprised in an sequence parameter set (SPS) of the parsed parameter information.

18. The video encoding method of claim 17, wherein the level information comprises at least one of a sample rate and a bit rate of the video data.

19. The video encoding method of claim 17, wherein the determining of the entry point determines the entry point of the video bitstream to be allocated to each of the video processing units so that a difference between numbers of pixels to be processed by the determined video processing units is minimized.

20. The video encoding method of claim 16, wherein each of the video processing units comprises a first processing unit and a second processing unit, and the video decoding method further comprises communicating by the first processing unit with the video central processing unit to perform entropy coding on the video data and processing by the second processing unit the entropy-coded video data into a coding unit.
